(19) United States
(12) Patent Application Publication
(10) Pub. No.: US 2014/0134293 A1
(43) Pub. Date: May 15, 2014

(54) ALLERGEN-FREE FOOD COMPOSITIONS

(71) Applicant: DMK DEUTSCHES MILCHKONTOR GMBH, BREMEN (DE)

(72) Inventor: Sven-Rainer Döring, ZEVEN (DE)

(73) Assignee: DMK DEUTSCHES MILCHKONTOR GMBH, BREMEN (DE)

(21) Appl. No.: 14/078,970

(22) Filed: Nov. 13, 2013

(30) Foreign Application Priority Data
Nov. 13, 2012 (EP) 12 192 448.4

(51) Int. Cl. A23C 21/02

(52) U.S. Cl. CPC A23C 21/02
USPC 426/41; 426/583

(57) ABSTRACT

Suggested are allergen-free food compositions, obtainable by
(a) heating raw milk in a manner known per se, removing solids from it and skimming the cream,
(b) subjecting the skimmed milk such obtained to microfiltration,
(c) subjecting the fine whey obtained as a first permeate to ultrafiltration,
(d) evaporating the second retentate obtained to a dry mass of from 30 to 50% by weight,
(e) subjecting the resulting whey protein concentrate to at least one hydrolysis step in the presence of at least one proteolytic enzyme,
(f) subjecting the resulting hydrolysate to heat treatment and, eventually,
(g) dehydrating the final product.

### AREA OF INVENTION

The invention is in the field of dairy products and relates to allergen-free food compositions on the basis of milk protein hydrolysates and a process for their production.

### PRIOR ART

Allergies against both cows' milk and dairy products which are specifically adapted to the requirements of infants are essentially due to the fact that the proteins originating from milk serum or from whey are different to the ones found in mother's milk and may thus constitute allergens. Among those, the main allergens to be mentioned are alpha-lactalbumin (aLA), beta-lactalbumin (bLG) and, to a lesser degree, also the immunoglobulins (particularly, IgG) as well as serum albumin (BSA).

The state of the art provides a number of processes for the production of low-allergen dairy products. Usually, sweet whey is the starting product which is obtained from cheese milk or vat milk by coagulation after adding rennet. By means of ultrafiltration sweet whey is then transferred to a whey protein concentrate, which is then hydrolysed using an endopeptidase, preferably, trypsin, as is described, for example, in EP 0226221 B1. Processes for the production of whey protein hydrolysates, which provide ultrafiltration as a final step, are known, for example, also from the publications GB 2043651 A or WO 1987 003785 A1 (Samuelsson).

Hydrolysis may also be carried out in a plurality of steps, wherein said steps are separated from one another by a heat treatment step in order to denaturate proteins that are still present and to make them more accessible to hydrolysis. Such a process is described, for example, in EP 0322589 B1 (Nestle).

EP 0353122 A1 suggests the use of an enzyme mixture of trypsin and chymotrypsin to produce a whey protein hydrolysate that does not contain any peptides having molecular weights of more than 5,000 Dalton. Hydrolysis is followed by ultra- or diafiltration also in this case.

International patent application WO 1993 004593 A1 (TEAGASC) discloses a process for the production of hypoallergenic whey protein hydrolysates, in which a substrate is subjected to hydrolysis with a proteolytic enzyme, subsequently the enzyme is thermally inactivated, and any undegraded macropeptides which may have an allergenic effect are removed from the resulting product by microfiltration.

Further it is referred to the Russian patent RU 2311039 C2 which also discloses products suitable for infant nutrition. Said products contain milk proteins and milk protein hydrolysates whose process of production also involves ultrafiltration steps.

The use of sweet whey as exclusively described by the prior art, however, shows considerable disadvantages with regard both to the remaining potential to cause allergies of the final products and to the composition of amino acids - which usually does not meet dietetic requirements for the following reasons. Cheese milk contains micelles, in which casein is bridged by calcium ions. The micelles carry a strong positive charge, repelling one another, which prevents the casein from coagulating. Therefore, to allow coagulation, the enzyme rennet is added to the cheese milk. Said enzyme separates the micelles, thereby reducing their surface charge such that the casein can coagulate and be separated for the production of cheese or curd. What remains is the sweet whey which now contains the rennet, specifically, para kappa casein (PKC). In doing so, its amino acids become a part of the amino acid mixture that originated from the whey proteins. However, the PKC proteins include far less essential amino acids than the whey proteins, reducing this important parameter in an undesired manner.

Adding rennet to cheese milk further leads to a breakdown of part of the whey proteins. Said breakdown is unspecific and uncontrollable, which makes it difficult to standardise the distribution of the amino acids when using sweet whey.

Another problem is that vat milk used for the production of a particular type of cheese is adjusted both in its fat content and in its protein content. During the production of the curd, when cutting the curd in the cheese vat, fat may leak out at the cutting areas. Said portion of fat is transferred into the whey. A large part of this fat consists of free fatty acids, which cannot be removed any more, even by a downstream skimming centrifuge, because they are free fatty acids. This is undesirable for dietetic reasons.

A further problem known from the prior art is the poor taste quality of the hydrolysates. It is closely connected with the degree of hydrolysis and the resulting distribution of amino acids in the peptides. In particular, peptides with a high portion of hydrophobic amino acids (e.g., Phe, Pro, Val, Trp, Leu or Ile) cause a bitter taste. At lower degrees of hydrolysis the taste receptors are unable to perceive these peptides due to their folding. In addition, at higher degrees of hydrolysis it may happen that the peptides unfold and may then interact with the receptors.

Therefore, to avoid a bitter taste, is has been required to select suitable enzymes and process conditions according to the principle of trial and error such that a bitter taste is avoided as a result. However, this requires a high experimental effort. For example, it may be possible to carry out a process in a technically simpler manner at lower temperatures, but before reaction can even begin, first of all, a new enzyme system would have to be found, which would require too much effort. It is obvious that there is a need for a process that allows a greater flexibility in this aspect.

The first object of the invention has thus been to provide food on the basis of whey protein hydrolysates, particularly for providing infant food, which, however, is at the same time allergen-free, has an improved composition of amino acids with respect to a dietetic nutrition, and is free of fats as well. Further, the process should be designed such that distributions of amino acids that are free of bitter taste are obtained largely independently of the nature of the proteolytic enzymes used, thus making the technical effort during a change of the individual process conditions—particularly during hydrolysis—much simpler.

### DESCRIPTION OF THE INVENTION

The subject matter of the invention are allergen-free food compositions having an improved composition of amino acids, obtainable by
(a) heating raw milk in a manner known per se, removing solids and skimming the cream,
(b) subjecting the skimmed milk such obtained to microfiltration,
(c) subjecting the fine whey resulting as first permeate to ultrafiltration,
(d) evaporating the resulting second retentate to a dry mass of from 25 to 50% by weight,
(e) subjecting the resulting whey protein concentrate to at least one hydrolysis step in the presence of at least one proteolytic enzyme,
(f) subjecting the resulting hydrolysate to heat treatment and, as a final step,
(g) dehydrating the final product.

A second subject matter of the invention relates to a process for the production of allergen-free food compositions having an improved composition of amino acids, in which
(a) raw milk is heated in a manner known per se, solids are removed and the cream is skimmed,
(b) the skimmed milk such obtained is subjected to microfiltration,
(c) the fine whey resulting as first permeate is subjected to ultrafiltration,
(d) the resulting second retentate is evaporated to a dry mass of from 30 to 50% by weight,
(e) the resulting whey protein concentrate is subjected to at least one hydrolysis step in the presence of at least one proteolytic enzyme,
(f) the resulting hydrolysate is subjected to heat treatment and, in a final step,
(g) the final product is dehydrated.

Surprisingly it has been found that the object of the invention can be completely solved by using fine whey instead of sweet whey. While sweet whey is produced using acidifying cultures and rennet to coagulate the vat milk, it is precisely those process steps that do not need to be carried out any more when fine whey is used. In particular, glycomacroproteins—which are otherwise separated from the casein by the rennet—are prevented from being transferred into the whey, thus adversely changing the composition of amino acids. In fact, using fine whey yields food compositions having a content of essential amino acids of, on average, about 3 to 8% by weight above the value which is attained when sweet whey is used. As a result of the microfiltration step the products are completely fat-free. Another advantage consists in the fact that the taste of the amino acid compositions is pleasant, so that the nature of the proteolytic enzymes is only a matter of subordinate importance.

### Production of the Skimmed Milk

To produce the skimmed milk, firstly, a separation of solids (“cheese fines”) and the skimming of a fat content of about 4% from the raw milk are performed. This is usually carried out within a particular component, preferably, a separator. Said components are adequately known from the prior art. Separators of the company GEA Westfalia Separator GmbH, which allow the joint or single use of both steps (http://www.westfalia- separator.com/de/anwendungen/molkereitechnik/milch-molke.html), are widely used in the dairy industry. Corresponding components have been disclosed, for example, also in DE 10036085 C1 (Westfalia) and are perfectly known to those skilled in the art. Thus no explanation is needed on how to carry out these process steps, as they are understood to be part of the general specialist knowledge.

The heat treatment of the raw milk is preferably performed in heat exchangers, whereby specifically plate heat exchangers have proven to be particularly suitable. There is a temperature gradient at the heat exchangers which, however, is selected such that the raw milk is heated to a temperature of from about 70 to 80° C. and, more particularly, from about 72 to 74° C., for a residence time of a minimum of 20 and a maximum of 60 seconds, preferably, about 30 seconds.

### Microfiltration and Ultrafiltration

Microfiltration is a process for substance removal. The essential difference between microfiltration and ultrafiltration lies in the different pore sizes and the different membrane structure as well as in the materials and filter materials involved. A filtration through membranes having a pore size of <0.1 μm is usually referred to as ultrafiltration, while a filtration using pore sizes of >0.1 μm is usually referred to as microfiltration. In both cases purely physical, i.e., mechanical membrane separation methods, which apply the principle of mechanical size exclusion, are concerned: all particles in the fluids, which are larger than the membrane pores, are retained by the membrane. The driving force in both separation methods is the differential pressure between the inlet and the outlet of the filter area, which is between 0.1 and 10 bar. The filter area material may consist of—depending on the area of application—stainless steel, synthetic material, ceramic or textile fabric. Filter elements appear in different forms: candle filters, flat membranes, spiral coil membranes, bag filters and hollow fibre modules, which are all principally suitable within the meaning of the present invention. Microfiltration is preferably carried out using membranes having a pore diameter of from about 0.1 to about 1.4 μm and, more particularly, of from about 0.1 to 0.2 μ. With this pore size a clean separation into casein (retentate) and whey proteins (permeate) can be obtained during a warm filtration in the range of from about 50 to 55° C. This pore size prevents thermophilic bacteria from growing through the membrane.

According to the invention, the fine whey obtained as permeate during microfiltration is then subjected to ultrafiltration to evaporate the protein contained therein and to separate lactose. In principle, this is performed in the manner described above, particularly at temperatures in the range of from about 10 to about 55, preferably of from about 10 to 20° C., wherein the membranes, however, preferably have a pore diameter in the range of from about 1,000 to about 50,000 and, more particularly, of from about 5,000 to about 25,000 Dalton. Particularly suitable are the so-called spiral coil membranes or plate-frame modules made of polysulfone, or polyethylene membranes.

### Hydrolysis and Heat Treatment

While the retentate obtained during ultrafiltration is used otherwise or discarded, the permeate is, firstly, gently evaporated to a dry mass of from about 30 to about 50% by weight, preferably, about 40% by weight, and is subsequently subjected to enzymatic hydrolysis involving at least one proteolytic enzyme. Said enzymes may be present in admixture, be purified, and have their peak activity both in the alkaline and the neutral ranges. Specifically, they can be endopeptidases such as trypsin, chymotrypsin or pankreatin. However, also enzymes of the papain type are suitable.

A preferred enzyme mixture is, for example, the product “Pancreatic Trypsin”, which is commercially available from Novo Industrie A/S. Said enzyme mixture is advantageous, because it allows to attain the desired degree of hydrolysis and leads to an advantageous molecular weight distribution of the peptides. With regard to the molecular weight distribution it is, in fact, advantageous to use from about 8 to about 15% by weight of the total portion of peptides in the area of from 5,000 to 50,000 Dalton, as this enhances the emulsion stability in the final products.

Preferably, hydrolysis is carried out at a temperature of from about 50 to about 90° C. and over a period of time of from about 10 minutes to about 24 hours, more preferably, from about 15 to 60 minutes at a pH value of from about 6 to 8. As is customary in chemistry, reaction time and temperature are linked to one another via the relationship of reaction time and temperature applied, i.e., higher temperatures allow for shorter hydrolysis times and vice versa.

Suitable reaction vessels are, for example, stirred tank reactors or tube reactors.

To avoid coagulation of the whey protein concentrate, a complexing agent such as, for example, calcium or magnesium citrate may be added, as is suggested, for example, in U.S. Pat. No. 4,748,034.

Hydrolysis is followed by heat treatment, which primarily serves to inactivate the enzyme. At the same time also non-hydrolysed peptides are denatured, which, as a result, makes them more accessible to degradation in a following hydrolysis step, which is possible as an option. Heat treatment may be performed in the same reaction vessel or locally separated from it. For example, it has been demonstrated that in industrial heat exchangers, which are particularly suitable for carrying out both hydrolysis and also heat treatment, temperatures of from about 80 to about 100° C. and residence times of from about 2 to about 10 min are sufficient to effect denaturation practically quantitavely.

### Dehydration

After treating the aqueous hydrolysate with proteolytic enzymes, it is transferred into a dry powder. Suitable processes are belt-drying, freeze-drying and, particularly, spray-drying. The powders usually have a residual moisture of from 1 to 5, preferably 2 to 3% by weight, in which the fat is distributed more or less evenly in the form of inclusions in the fat-free dry substances, i.e. proteins, sugars and salts.

### Process Flow

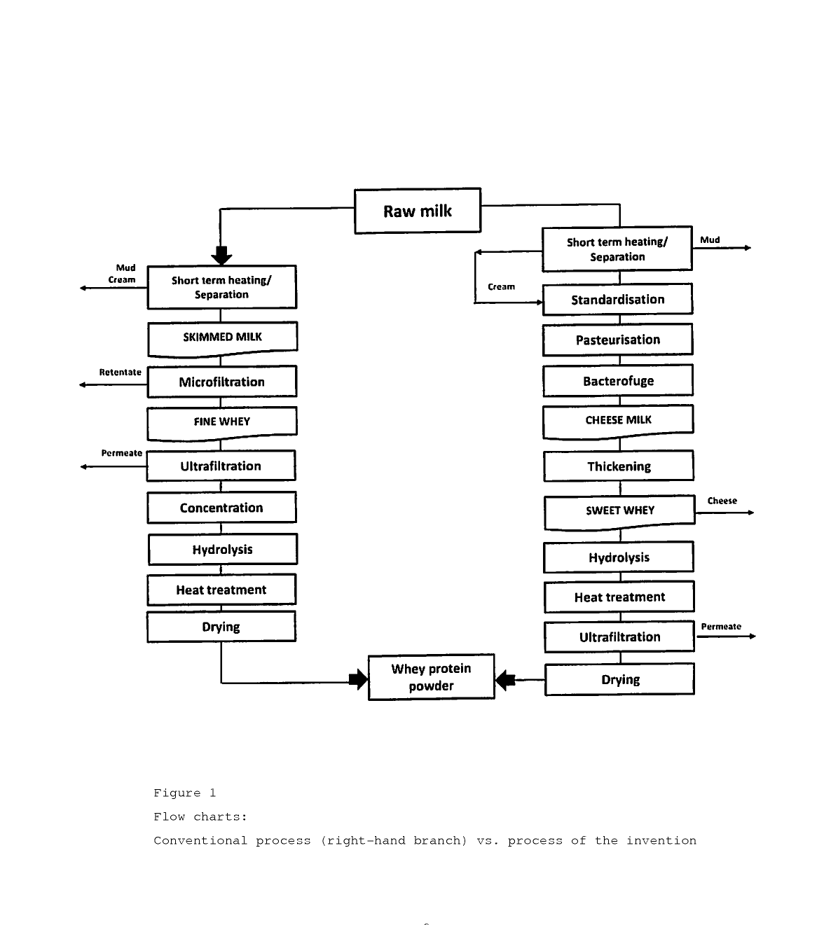

The invention is explained in more detail by FIG. 1 below which illustrates the process by means of a flow chart.

The right-hand side branch of the chart illustrates the conventional production of whey protein hydrolysate powders. During this process, raw milk is firstly subjected to short-time heating and then, when it is in a heated condition, it is separated from slime in a separator. Skimming is performed at the same time. The skimmed milk obtained is now adjusted to a defined fat content (“standardized”) using a certain amount of cream and is subsequently pasteurized, i.e., it is heated up to a temperature of from 72 to 74° C. for about 30 seconds. To separate the spores formed during the two heating steps, further mechanical separation is then carried out in a bactofuge. The bacteria concentrate is removed and the pasteurized milk, which is now referred to as cheese milk or vat milk, is coagulated by adding rennet. After curdling, the cheese or quark is removed, and the liquid phase which is referred to as sweet whey is further processed. In a first step, a proteolytic enzyme is added to the sweet whey and hydrolysed at about 90° C. and a pH of 6 for a period of about 10 minutes. The mixture is subsequently subjected to heat treatment in which the temperature is raised to up to 100° C. for a few minutes in order to inactivate the enzyme. The process steps of adding enzyme, hydrolysis and heat treatment can be repeated several times. The product is subsequently subjected to ultrafiltration and spray-dried. Ultrafiltration, however, is preferably carried out before adding the enzyme to obtain a better enzyme-substrate ratio.

The left-hand side branch of the chart illustrates the process according to the invention. Raw milk is, as above, firstly subjected to short-time heating and then, when it is in a heated condition, it is separated from slime in a separator. Skimming is performed at the same time. The skimmed milk such obtained is firstly subjected to microfiltration to produce fine whey as permeate, which subsequently is subjected to ultrafiltration. Enzymes are added to the retentate such obtained—as described above, if necessary, repeatedly—which is then hydrolysed, subjected to heat treatment and, eventually, spray-dried.

### Industrial Application

A further subject matter of the invention relates to the use of fine whey to produce allergen-free food compositions such as, particularly, infant food, specifically applying the process of the invention described above.

1. Allergen-free food compositions, prepared obtainable by the steps of
(a) heating raw milk in a manner known per se, removing solids from it and skimming the cream,
(b) subjecting the skimmed milk such obtained to microfiltration,
(c) subjecting the fine whey obtained as a first permeate to ultrafiltration,
(d) evaporating the second retentate obtained to a dry mass of from 30 to 50% by weight,
(e) subjecting the resulting whey protein concentrate to at least one hydrolysis step in the presence of at least one proteolytic enzyme,
(f) subjecting the resulting hydrolysate to heat treatment and, eventually,
(g) dehydrating the final product.

2. Process for the production of allergen-free food compositions, wherein
(a) raw milk is heated using a manner known per se, the solids are removed and the cream is skimmed,
(b) the skimmed milk such obtained is subjected to microfiltration,
(c) the fine whey obtained as a first permeate is subjected to ultrafiltration,
(d) the resulting second retentate is evaporated to a dry mass of from 30 to 50% by weight,
(e) the resulting whey protein concentrate is subjected to at least one hydrolysis step in the presence of at least one proteolytic enzyme,
(f) the resulting hydrolysate is subjected to heat treatment and, eventually,
(g) the final product is dehydrated.

3. The process according to claim 2, wherein microfiltration of the skimmed milk is carried out by means of a membrane having a pore diameter of from 0.1 to 0.2 μm.

4. The process according to claim 2, wherein ultrafiltration of the fine whey is carried out at a temperature of from 10 to 55° C.

5. The process according to claim 2, wherein ultrafiltration of the fine whey is carried out by means of a membrane having a pore diameter of from 1,000 to 50,000 Dalton.

6. The process according to claim 5, wherein polymer membranes are used.

7. The process according to claim 2, wherein hydrolysis is carried out using proteolytic enzymes selected from the group consisting of trypsin, chymotrypsin, pankreatin, papain and mixtures thereof.

8. The process according to claim 2, wherein hydrolysis is carried out at temperatures of from 50 to 90° C.

9. The process according to claim 2, wherein characterized in that hydrolysis is performed over a period of time of from 10 minutes to 24 hours.

10. The process according to claim 2, wherein hydrolysis is carried out at a pH value of from 6 to 8.

11. The process according to claim 2, wherein heat treatment is carried out at a temperature of from 80 to 100° C.

12. The process according to claim 2, wherein heat treatment is carried out over a period of from 2 to 10 minutes.

13. The process according to claim 2, wherein the compositions are dehydrated by belt drying, freeze drying or spray drying.

14-15. (canceled)

16. The composition of claim 1, said food composition being an allergen-free infant food composition.
